(19) United States
(12) Patent Application Publication
(10) Pub. No.: US 2003/0150280 A1
(43) Pub. Date: Aug. 14, 2003

(54) Liquid meter

(76) Inventor: Christophe Meistermann, Lutterbach (FR)

Correspondence Address: YOUNG & THOMPSON, 745 SOUTH 23RD STREET 2ND FLOOR, ARLINGTON, VA, 22202

(21) Appl. No.: 10/325,823

(22) Filed: Dec. 23, 2002

(30) Foreign Application Priority Data
Dec. 21, 2001 (FR) 01 16788

(51) Int. Cl. G01F 1/05

(52) U.S. Cl. 73/861.79

(57) ABSTRACT

A liquid meter has constituent elements including a body, an immersed rotatable measuring device, a totalizer, a sealed separation in a dry region, transmission elements for the movement of the measuring device to the totalizer. The constituent elements are arranged in the form of independent modules including a measuring module, a totalizing module, a locking module and a filtration module. The constituent elements include respectively complementary assembly elements permitting their assembly with the body of the meter and/or with each other to constitute the meter.

The present invention relates to a liquid meter, in particular of the volumetric or turbine type.

The water meter of the volumetric or turbine type is conventionally comprised by a body of brass or synthetic material comprising a filter, a measuring device, a display, a sealed partition separating the immersed measuring device and a display in a dry region, a magnetic system for transmission of the movement of the measuring device to the display and a locking member ensuring both cohesion of the assembly and the sealing of the meter according to the regulations in force relating to measuring apparatus.

Such a water meter is in particular described in the patents belonging to the applicant FR-B-2 753 152 and FR-B-2 789 173.

This type of meter however has a drawback in that the replacement of one of its constituent elements, during repair, is not easy and requires substantially complete disassembly of the elements one by one of said meter, which causes a loss of time as well as relatively high cost.

Also, the object of the invention is to provide a meter in which the replacement of each of the constituent elements is facilitated such that the repair of said meter is easy, rapid and less costly and that it is possible to practice said repair on the site of installation of said meter if the rules permit.

To this end, the invention has for its object a liquid meter, in particular of the volumetric or turbine type, in which the constituent elements are a body, an immersed rotatable measuring device, a totalizer, a sealed separation between said immersed measuring device and the totalizer in a dry region, means for transmission of the movement of the measuring device to the totalizer, said constituent elements being arranged in the form of independent modules comprising a measuring module and a totalizing module, the measuring module being constituted by the complete measuring chamber and at least one rotatable magnet transmitting the movement of the measuring instrument, characterized in that it moreover comprises as constituent elements a locking module and a filtration module, the constituent elements comprising respectively complementary assembly means permitting their assembly with the body of the meter and/or with each other to constitute said meter.

Thus preferably, the modules according to the invention constitute finished subassemblies of constituent elements of the meter which are perfectly separable from each other without requiring disassembly of the meter element by element.

Thus, the liquid meter, in particular for water, according to the invention, comprises a body in which are mounted a filtration module, a measuring module, a display module and a locking module.

The filtration module is essentially constituted by a filter having a filtering surface which passes cross-section is at least equal to that of the inlet tubing for liquids and whose mesh size permits stopping solid particles such that there can be obtained a good protection of the measuring members against foreign bodies.

During poorly controlled work on the water lines, accidents such as the massive arrival of sand, can take place and have for a consequence the clogging of the filter which, under the effect of pressure, deforms and bursts, letting the solid particles migrate through the measuring chamber and destroying this latter before flowing to the point of use of the user.

So as to avoid bursting of the filter, the filtration module comprises an armature comprising small support pillars which oppose the deformation of the filtering surface.

In this way, there is desirably avoided the bursting of the filter and the only phenomenon which takes place consists in a notable drop in water pressure, causing the user to call the maintenance service.

The measuring module is constituted by the complete measuring chamber, at least one rotatable magnet transmitting movement of the measuring instrument, and a sealing plate.

The complementary assembly means of said measuring module are constituted of at least two longitudinal bars, preferably of different cross-sections, provided on the external surface of the measuring chamber, serving as a guide and positioning means for said module in the recess of the meter body, and screwing means provided on the external periphery of the sealing plate to coact with complementary screwing means on the body of the meter, said sealing plate being mounted on the measuring chamber, freely in rotation relative to the latter.

Preferably, the measuring module can be calibrated separately from the meter on calibrating banks designed for this effect. Thus, although not having a totalizer, it is easy to add it for the duration of calibration or also to use the rotation of the transmission magnet to actuate an electronic detector.

The measuring module according to the invention is thus an interchangeable metering member permitting guaranteeing the setting of the meter after exchange.

A known characteristic of the volumetric measuring systems being in sensitivity to small variations of internal volumes of the meter bodies, it will be understood that the moderate measuring module according to the invention is an interchangeable measuring member permitting guaranteeing the accurate measurement of the meter after an exchange.

The totalizing module is comprised by a housing enclosing at least one rotatable magnet drivable by the rotatable magnet of the measuring module and a totalizer. The complementary assembly means of said totalizing module are constituted by the external shape of said housing adapted to be disposed in a recess provided in the upper portion of the sealing plate of the measuring module.

The locking module is constituted by a locking cap shaped to cover the totalizing module and to extend to the wall of the meter body and which comprises as complementary assembly means, irreversible anchoring members on the measuring module.

Thus, after mounting of the locking module, the latter cannot be withdrawn without destruction such that it constitutes the regulatory sealing member of the water meter.

Preferably, it is possible to add to the meter according to the invention external elements such as electric pulse emitters or a radio transmission system of the index of the meter for example, called “external modules”.

The invention will now be described in greater detail with reference to the drawings, in which:

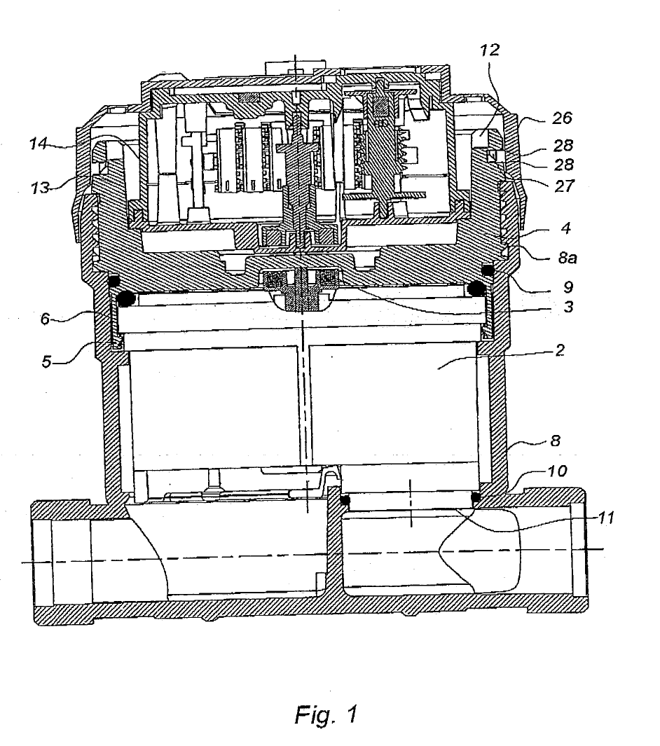

FIG. 1 is a longitudinal cross-sectional view of a water meter according to the invention;

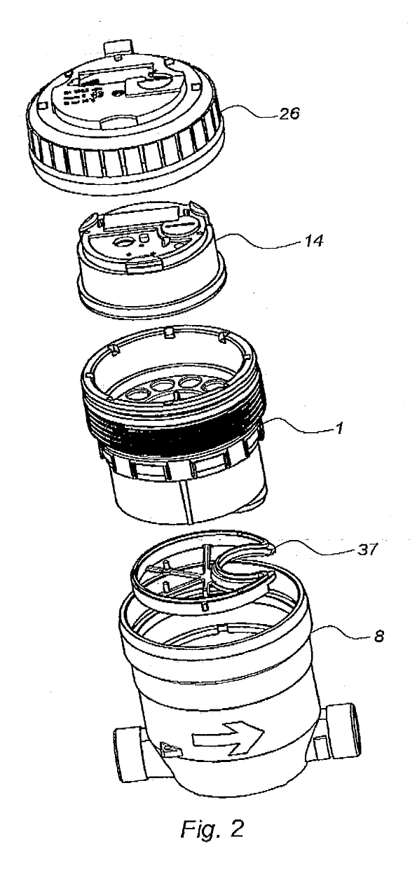

FIG. 2 is an exploded perspective view of the meter according to FIG. 1;

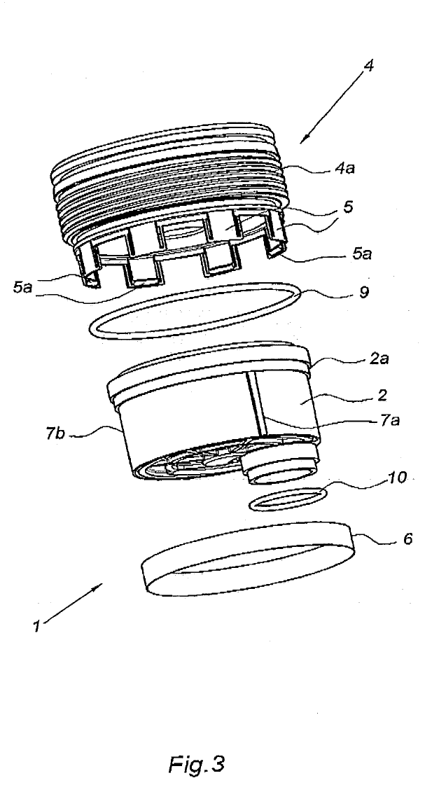

FIG. 3 is an exploded perspective view from below of the measuring module of the meter according to FIG. 1;

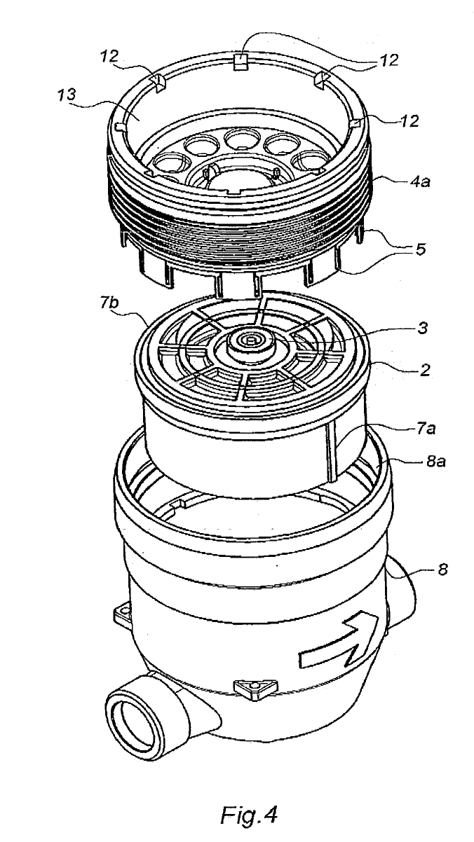

FIG. 4 is an exploded perspective view from above of the measuring module of the meter according to FIG. 1;

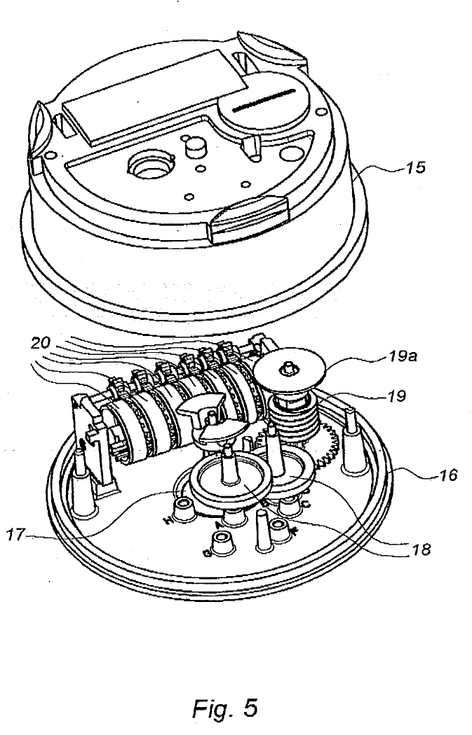

FIG. 5 is an exploded perspective view from above of the display module of the meter according to FIG. 1;

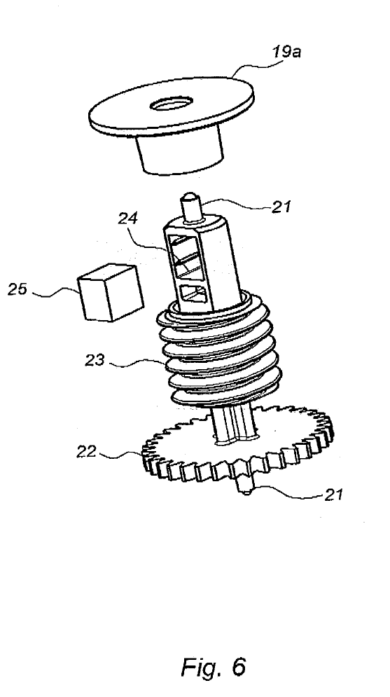

FIG. 6 is an exploded perspective view of the indicator disk of the display module according to FIG. 5;

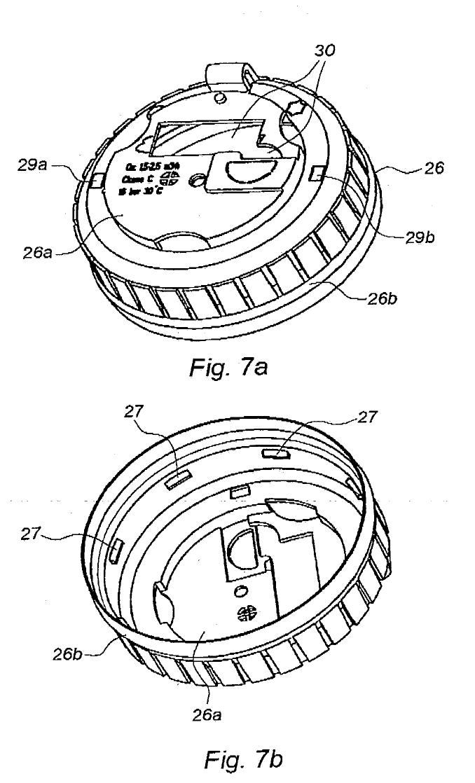

FIGS. 7a and 7b are perspective views from above and from below of the locking module of the meter according to FIG. 1;

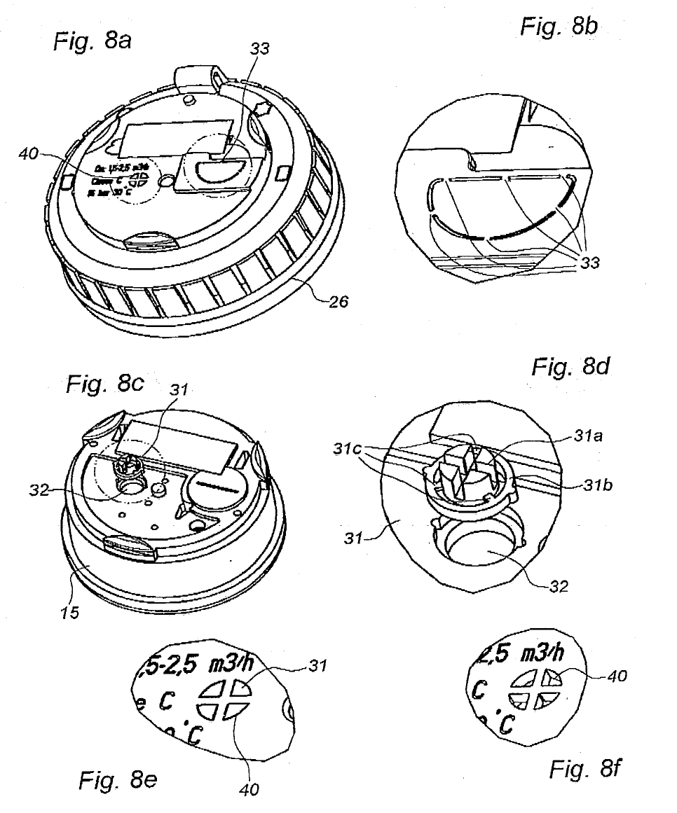

FIGS. 8a, 8b, 8c, 8d, 8e and 8f are respectively a perspective view from above of the locking module and details of said locking module according to FIG. 7a;

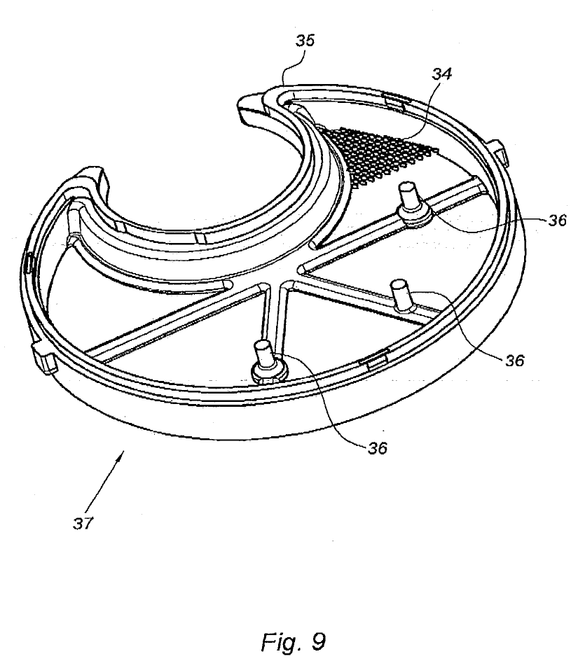

FIG. 9 is a perspective view from above of the filtration module.

The water meter according to the invention is constituted by a body 8 comprising a measuring module 1, a display module 14, a locking module 26 and a filtration module 37, as can be seen in FIG. 2.

The measuring module 1 is comprised by the complete measuring chamber 2, a rotatable magnet 3 transmitting movement of the measuring instrument, and a sealing plate 4.

The sealing plate 4 constitutes the sealed partition separating the immersed portion from the dry portion of the meter.

The sealing plate 4 is mounted on the measuring chamber 2 and comprises for this purpose a crown of resilient blades 5 called “clips” which comprise retaining teeth 5a (see FIG. 3), said crown surrounding the upper portion of the measuring chamber 2 once the sealing plate 4 is in place, whilst the retaining teeth 5a coact with a continuous peripheral shoulder 2a provided set back from the upper portion of the measuring chamber 2.

Thus, during emplacement of the sealing plate 4 on the measuring chamber 2, the resilient blades 5 because of the retaining teeth 5a are resiliently spaced outwardly and once the plate 4 is in place, the resilient blades 5 return to their initial position, the retaining teeth 5a being disposed below the shoulder 2a.

The sealing plate 4 is accordingly mounted on the measuring chamber 2, freely in rotation relative to the latter, the shoulder 2a being peripheral and continuous.

The measuring chamber 2 has on its external surface at least two longitudinal bars 7a and 7b preferably of different cross-sections and which permit guided mounting of the measuring module in the recess of the body 8 of the meter and the correct emplacement of said module 1.

Moreover, the sealing plate 4 has on its external periphery screwing means such as a screw thread 4a which coacts with complementary screwing means such as a screw threaded portion 8a provided in the body 8 of the meter.

Thus, when the measuring module 1 is mounted in the body 8 of the meter, the bars 7a and 7b permit its correct positioning in said body 8 whilst the complementary screwing means of the sealing plate 4 and the body 8 permit its securement in the body 8.

A sealing ring 6 as can be seen in FIGS. 1 and 3, guarantees that no fraudulent attempt of disassembly of said measuring module 1 can be practiced.

Between the measuring chamber 2 and the sealing plate 4, there is emplaced a joint 9 which ensures sealing between the two whilst a joint 10 ensures sealing between the chamber 2 and the outlet orifice of the water 11 (outlet of the meter).

So as to facilitate screwing of the measuring module 1, there is provided in the upper portion of the sealing plate a series of notches 12, for example eight, which serve to receive a special tool for screwing.

Moreover, the upper portion of the sealing plate 4 comprises a cavity 13 adapted to receive the totalizing module 14.

The totalizing module 14 seen in FIG. 5 is comprised by a sealed housing constituted by a capsule 15 and a socket 16 preferably made of transparent synthetic material and welded to each other at their periphery to effect sealing. The transparent synthetic material comprising the capsule as well as the socket is selected so as to guarantee the best homogeneity of the weld.

The capsule 15 and the socket 16 are shaped so as to have suitable bearings to serve as plates for at least one rotatable magnet 17 drivable in rotation by the transmitting rotatable magnet 3 of the measuring module 1, to a train of demultiplying gears 18, to a display disc 19 and to a train of digital rollers 20 of the display called “ogometer”.

The indicator disk 19 as is shown in FIG. 6 is comprised by an axle 21 carrying the final gear 22 of the kinematic train and an endless screw for driving the ogometer 23.

The indicator disk 19a properly so called carries at its lower periphery a cylinder which will cover and lock a magnet 25 adapted to control the operation of an external module. This magnet 25 is disposed in a recess 24 provided on the axle 21 and is thus well-centered on the axle 21 of the indicator disk 19. There is thus avoided a resistant couple which could result if the magnet 25 were slightly off center and which would be adapted seriously to alter the metrological properties of the meter. There is accordingly obtained the pssibility of perfectly positioning the magnet 25 and to lock it in the selected position.

The locking module shown in FIGS. 7a, 7b and 8a-8e is constituted by a locking cap 26.

This cap 26 is in the form of a disk 26a provided with a peripheral cylindrical skirt 26b. The cylindrical skirt 26b has, on its internal surface, a series of anchoring members arranged to project, such as teeth 27, adapted to fix the cap 26 immovably, the teeth 27 coacting with a continuous peripheral groove 28 provided on the measuring module 1 (see FIG. 1).

The teeth 27 being engaged in the peripheral continuous groove 28, the locking cap 26 is drivable in rotation relative to the measuring module 1.

To the extent that the disk 26a of the locking cap 26 will cover the upper portion of the totalizing module 14, it is shaped to mate with the upper portion of the totalizing module 14 and it comprises an opening 30 which permits observing the indications of the ogometer 20 and of the indicator disk 19.

Because of this, during rotation of the locking cap 26, there is also driven in rotation the totalizing module 14, and it is thus possible to orient the locking module 26 and hence the totalizing module 14 to facilitate reading of the indications of the ogometer 20.

The locking cap 26, once mounted, cannot be removed without destruction. Also, for disassembly of the meter for repair or exchange of the meter module, the locking cap 26 has rupture points, preferably two, 29a and 29b, which permit the introduction of a special disassembly tool. The rupture of these points 29a and 29b constitutes a rupture of the seals and the destruction of the cap 26 and upon remounting, it is necessary to use a new locking cap 26.

When the regulations permit, it is possible to remount the removed cap 26 and the rupture points 26a and 26b are thus closed by special self-adhering stickers. The removal of these stickers causes their self-destruction and they can carry periodic metrological inspection marks.

The filtration module 37 visible in FIG. 9 is comprised by a filtering surface 34 whose passage cross-section is at least equal to that of the inlet tubing of the water and whose mesh size permits stopping solid particles of the order of 0.8 mm in diameter, for example, such that there can be obtained a good protection of the measuring members against foreign bodies.

So as to avoid bursting of the filter during accidents, the filtration module 37 comprises an armature 35 comprising small support pillars 36 which oppose the deformation of the filtering surface 34.

The totalizing module 14 of the meter according to the invention can be the object of attempted fraud with clamps. Thus, ill-intentioned persons use such clamp to deform temporarily the totalizer of the meter so as to block the gearing and as a result stop the metering.

When this fraud is habitually practiced, it is impossible after withdrawal of the clamp to know that it has taken place. The totalizing module which forms a portion of the present invention comprises two devices for detection of this type of fraud.

The first device is constituted by an indicator 31 designed as a rupture piece of a bright color, constituted by a central portion 31a, a peripheral portion 31b interconnected by rupture zones 31c. The indicator 31 is placed in line with a well 32 provided in the upper portion of the capsule of the totalizing module 26. This piece 31 is fixed during final assembly of the meter by the addition of the locking cap 26. An opening 40 in the upper surface of said locking cap 26 permits ensuring that said indicator 31 is still in place. During attempted fraud, upon the least deformation, the indicator 31 breaks into two parts. The central portion 31a of the indicator 31 falls into the well 32 and becomes invisible, thereby signaling that a fraud has taken place.

The well 32 is blind in its lower portion such that the rupture piece cannot block viewing of the totalizer as happens in certain fraud indicating devices.

The second fraud detection device which is supplemental to the preceding one, consists in providing rupture lines 33 on the upper surface of the locking cap 26 in line with the indicator disk 19. When fraud is attempted so as to block in particular the indicator disk 19, the rupture of this zone indicates attempted fraud.

1. Liquid meter, in particular of the volumetric or turbine type, comprising as constituent elements a body (8), a filter, a measuring chamber (2) in which is disposed an immersed rotating measuring device, a totalizer, a sealed separation between immersed measuring device and the totalizer in a dry region, transmission means for the movement of the measuring device to the totalizer, said constituting elements being arranged in the form of independent modules comprising a measuring module (1) and a totalizing module (14), the measuring module (1) being constituted by the complete measuring chamber (2) and at least one rotatable magnet (3) for transmitting movement of the measuring instrument,
characterized in that it moreover comprises as constituent elements a locking module (26) and a filtration module (37), said constituent elements comprising respectively a supplemental assembly means permitting their assembly with the body of the meter and/or with each other to constitute said meter.

2. Liquid meter according to claim 1,
characterized in that the supplemental assembly means of said measuring module (1) are constituted by at least two longitudinal bars (7a, 7b) , preferably of different cross-sections, provided on the external surface of the measuring chamber (2), serving as guiding and positioning means for said module (1) in the recess of the body (8) of the meter, and screwing means (4a) provided on the external periphery of a sealing plate (4) of said measuring module to coact with complementary screwing means (8a) on the body (8) of the meter, said sealing plate (4) being mounted on the measuring chamber (2), freely in rotation relative to the latter.

3. Liquid meter according to claim 2,
characterized in that the sealing plate (4) comprises a crown of resilient blades (5) called “clips” which comprise retaining teeth (5a), said crown surrounding the upper portion of the measuring chamber (2) once the sealing plate (4) is in place, whilst the retaining teeth (Sa) coact with a continuous peripheral shoulder (2a) provided set back in the upper portion of the measuring chamber (2).

4. Liquid meter according to claim 1,
characterized in that the totalizing module (14) is comprised by a casing enclosing at least one rotatable magnet (17) drivable by the rotatable magnet (3) of the measuring module (1) and a totalizer, the housing being sealed and constituting a capsule (15) and a socket (16) preferably made of transparent synthetic material and welded to each other at their peripheries to create the seal, said capsule (15) and socket (16) being shaped to have suitable bearings to serve as plates for at least one rotatable magnet (17), a train of demultiplying gears (18), a train of digital rollers (20) for the display called “ogometer” and an indicator disk (19) which is comprised by an axle (21) carrying the last gear (22) of the kinematic train and an endless screw for driving the ogometer (23), the indicator disk properly so-called (19a) carrying on its lower periphery a cylinder which covers and locks a magnet (25) adapted to control the operation of an external module.

5. Liquid meter according to claim 2,
characterized in that the supplemental assembly means of said totalizing module (14) are constituted by the external shape of said housing adapted to be received in a cavity provided in the upper portion of the sealing plate (4) of the measuring module (1).

6. Liquid meter according to claim 1,
characterized in that the locking module is constituted by a locking cap (26) which is in the form of a disk (26a) provided with a peripheral cylindrical skirt (26b) shaped to receive the totalizing module (14) and extending to the wall of the body (8) of the meter and which comprises, on its internal surface, as complementary assembly means, a series of irreversible anchoring members on the measuring module (1), provided in projection such as teeth (27), adapted to fix the cap (26) irremovably, the teeth (27) being engageable in a continuous peripheral groove (28) provided on the measuring module (1), said locking cap (26) drivable in rotation relative to said measuring module (1) having rupture points, preferably two, (29a) and (29b) for the introduction of a special disassembly tool.

7. Liquid meter according to claim 1,
characterized in that the filtration module (37) is constituted by a filter having a filtering surface (34) whose passage cross-section is at least equal to that of the inlet tubing for liquid and whose mesh size permits stopping solid particles, the filtration module (37) moreover comprising an armature (35) comprised by small support pillars (36) which oppose the deformation of the filtering surface (34).

8. Liquid meter according to claim 1,
characterized in that it comprises a device for the detection of fraud by clamping, which is constituted by an indicator (31) designed as a rupture member of bright color, disposed in line with a well (32) provided in the upper portion of the capsule of the totalizing module (14), said indicator (31) being immobilized during final assembly of the meter by the addition of the locking cap (26) whilst an opening in an upper surface of said locking cap (26) permits ensuring that said indicator (31) is still in place and, said indicator (31) being breakable upon the slightest deformation during attempted fraud such that the central part of the indicator (31) falls into the well (32) and becomes invisible, thereby indicating that a fraud has been attempted.

9. Liquid meter according to claim 1, characterized in that it comprises a device for fraud detection constituted by rupture lines (33) provided on the upper surface of the locking cap (26) in line with the indicator disk (19), said region breaking during attempted blocking of the indicator disk (19).
